(19) United States
(12) Patent Application Publication
(10) Pub. No.: US 2025/0050371 A1
(43) Pub. Date: Feb. 13, 2025

(54) RESIN APPLICATION DEVICE FOR A CONVEYING SURFACE IN A PRINTING PROCESS, ASSEMBLY FOR PREPARING A CONVEYING SURFACE TO RECEIVE A SUBSTRATE IN A PRINTING PROCESS, METHOD OF PREPARING A CONVEYING SURFACE TO RECEIVE A SUBSTRATE IN A PRINTING PROCESS AND METHOD OF PRINTING A SUBSTRATE

(71) Applicant: SYSTEM CERAMICS S.P.A., Fiorano Modenese (IT)

(72) Inventors: Marco Valentini, Fiorano Modenese (IT); Fabio Tommasi, Fiorano Modenese (IT)

(21) Appl. No.: 18/721,372

(22) PCT Filed: Dec. 21, 2022
(86) PCT No.: PCT/IB2022/062614

§ 371 Date: Jun. 18, 2024

(30) Foreign Application Priority Data
Dec. 22, 2021 (IT) 102021000032261
Dec. 22, 2021 (IT) 102021000032282

(51) Int. Cl. B05C 5/02; B05C 11/02; B41J 11/00

(52) U.S. Cl. CPC B05C 5/0245; B05C 11/025; B41J 11/0015

(57) ABSTRACT

A resin application device (100) for a conveying surface (16) in a printing process comprises: an adhesive resin dispenser (170) configured to deliver adhesive resin (180) onto a conveying surface (16); a dragging body (150) rotatably mounted about a rotation axis (R) and configured to come into contact with the conveying surface (16), wherein in a contact zone (156) between the dragging body (150) and the conveying surface (16), the dragging body (150) and the conveying surface (16) have respective advancement directions directed in opposite to each other; a motor (155) connected to said dragging body (150) for setting into rotation said dragging body (150) about said rotation axis (R); a support frame (101) on which said dragging body (150) is mounted and configured to be mounted on the conveying surface (16).

### CROSS-REFERENCE TO RELATED APPLICATION DATA

This application is a U.S. National Stage Application of International Application No. PCT/IB2022/062614, filed Dec. 21, 2022, which claims the benefit of and priority to Italian Patent Application No. 102021000032261, filed Dec. 22, 2021 and Italian Patent Application No. 102021000032282, filed Dec. 22, 2021, the disclosure of each is incorporated herein in its entirety.

### FIELD

The present invention refers to a resin application device for a conveying surface in a printing process, an assembly for preparing a conveying surface to receive a substrate in a printing process, a method of preparing a conveying surface to receive a substrate in a printing process, and a method of printing a substrate.

### BACKGROUND

In inkjet textile printing, a textile substrate (by textile substrate being meant non-rigid and deformable substrates not necessarily made of fabric) is carried by a conveyor belt under one or more printheads consisting of one or more inkjet heads configured to emit drops of ink in a controlled manner to decorate the substrate according to a pre-established printing pattern. The correct positioning and the planarity of the substrate under the head at the time of printing are of particular importance to avoid printing defects.

In order to achieve a correct printing of the substrate, it must be avoided that the substrate is subjected to even minor deformations during printing, it must be ensured that the substrate does not shift with respect to a reference positioning during the printing process and it must be ensured a perfect planarity of the substrate.

For this reason, the substrate is usually made to adhere to a surface of the conveyor belt in such a way that the latter creates a substantially perfectly planar reference surface during the printing step, preventing the substrate from being subjected to stretching during printing and preventing the substrate from being able to shift with respect to the conveyor belt during printing.

The adhesion of the substrate to the surface of the conveyor belt is usually obtained by previously subjecting the surface of the conveyor belt to a so-called “resin application” process.

This resin application process envisages spreading a layer of adhesive resin as evenly as possible on the surface of the conveyor belt. The resin applied on the conveyor belt in a liquid and viscous state solidifies by evaporation of solvents.

The applied resin layer can be subsequently activated, for example by heating the adhesive resin, so as to prepare the surface of the conveyor belt to receive and retain the substrate.

The adhesive resins that are usually used have such an adhesiveness that allows the substrate to be easily detached from the surface of the conveyor belt, preventing the substrate from being damaged during removal.

Furthermore, the adhesive resins usually used are able to guarantee sufficient adhesive properties over time both to stably retain the substrate during the printing process and to allow a plurality of substrates to be positioned, printed and subsequently removed from the surface of the conveyor belt.

When the adhesive resin applied on the conveyor belt wears out and degrades (loses its adhesive characteristics and/or evenness) as a result of repeated uses, it is usually necessary to reapply a new layer of adhesive resin on the layer that is no longer adhesive. Only when the overlapping of many layers of adhesive resin is excessive, all the applied layers of adhesive resin should be removed, e.g. by deep-washing the carpet of the conveyor belt, and a new layer of adhesive resin be applied. Before removing all the layers of resin 5 consecutive resin application sessions are carried out to save time.

Before the application of the adhesive resins, other categories of products called “levelling agents” can be used in order to pre-treat the carpet in order to make the adhesion process of the resin more effective. For example, levelling agents are used to correct carpet imperfections (grooves or scratches) and/or to homogenize the surface in the event that the adhesive resin is deposited on a carpet where the previously worn out resin layer has not been removed.

In the Applicant's experience, the adhesive resin is usually applied on the surface of the conveyor belt by delivering the adhesive resin onto the surface of the conveyor belt while the latter is advanced along an advancement direction. A doctor blade in the form of a metal bar or other material is placed in contact with the surface of the conveyor belt and arranged transversely to the latter. Said doctor blade exerts a pressure on the surface of the conveyor belt so that an even layer of adhesive resin is allowed to pass between the doctor blade and the surface of the conveyor belt. The adhesive resin is delivered onto the surface of the conveyor belt upstream of the doctor blade so that the latter intercepts the adhesive resin being conveyed. The doctor blade makes an even layer of controlled thickness pass between the doctor blade and the surface of the conveyor belt. The adhesive resin can be applied continuously by circulating the conveyor belt around pulleys so that layers of adhesive resin overlap on each other.

The Applicant has verified that the adhesive resin intercepted by the doctor blade tends to accumulate and stagnate in front of the doctor blade because the adhesive resin is delivered in excess on the surface of the conveyor belt to ensure that the doctor blade can spread the adhesive resin along the entire width of the conveyor belt.

The Applicant has noted that if an impurity, for example a corpuscle, comes into contact with the adhesive resin between the delivery zone and the doctor blade, such impurity tends to be conveyed integrally with the adhesive resin until reaching the doctor blade. When the impurity reaches the doctor blade, the impurity tends to stagnate in front of the doctor blade.

The Applicant has verified that when this happens, the impurity creates a localized obstruction to the passage of the adhesive resin causing a kind of straight groove in the layer of adhesive resin downstream of the doctor blade.

This continuous groove creates a discontinuity in the evenness of the layer of adhesive resin downstream of the doctor blade.

When the dimensions of the impurity are very small, the Applicant has noted that the impurity passes through the doctor blade remaining on the surface of the conveyor belt and creating a micro-relief in the layer of adhesive resin downstream of the doctor blade.

The Applicant has noted that any unevenness of the layer of adhesive resin applied on the conveyor belt, such as straight grooves or micro-reliefs in the even layer of adhesive resin, may create localized planarity defects of the substrate being conveyed by the conveyor belt.

The Applicant has verified that such localized planarity defects may compromise the printing quality on the substrate in an inkjet printing process.

The Applicant has therefore felt the need to have a method of preparing a conveying surface to receive a substrate in a printing process and a method of printing a substrate that avoids the formation of straight grooves and micro-reliefs in the even layer of adhesive resin.

The Applicant has perceived that, if stagnation of the adhesive resin were avoided in a release zone from which the even layer of adhesive resin is subsequently formed and spread on the surface of the conveyor belt, it could be prevented any impurities present in the adhesive resin from accumulating in this release zone and therefore straight grooves or micro-reliefs from being created on the even layer of adhesive resin formed on the surface of the conveyor belt.

The Applicant has found that by displacing adhesive resin from said release zone by dragging the adhesive resin towards a region on the conveying surface placed upstream of said zone, the adhesive resin that would tend to accumulate and stagnate in said release zone would be constantly moved away from the release zone and any impurities contained therein would also be constantly moved away from the release zone.

The Applicant has further found that by providing a dragging body rotatably mounted on the conveying surface, it would be possible to use such a dragging body to even out the adhesive resin deposited on the conveying surface by creating an even layer of adhesive resin.

The Applicant has also found that this dragging body, by effect its rotation, tends to remove the adhesive resin that accumulates in front of the dragging body from the release area. The adhesive resin removed from the dragging body is transferred, by effect of the rotation of the dragging body, towards a region on the conveying surface placed upstream of the release zone and any impurities contained in the adhesive resin are also constantly removed from the release zone.

The Applicant has further found that such constant action of dragging the adhesive resin towards a region on the conveying surface upstream of the release zone creates a forced recirculation of adhesive resin that can prevent any impurities from reaching the release zone, adhering onto the conveying surface or getting stuck between the dragging body and the conveying surface.

### SUMMARY

The present invention therefore concerns, in a first aspect thereof, a resin application device for a conveying surface in a printing process.

Preferably, there is provided an adhesive resin dispenser configured to deliver adhesive resin on a conveying surface.

Preferably, there is provided a dragging body rotatably mounted about a rotation axis.

Preferably, the dragging body is configured to come into contact with the conveying surface.

Preferably, in a contact zone between the dragging body and the conveying surface, the dragging body and the conveying surface have respective advancement directions directed opposite to each other.

Preferably, there is provided a motor connected to said dragging body for setting into rotation said dragging body about said rotation axis.

Preferably, there is provided a support frame on which said dragging body configured to be mounted on the conveying surface is mounted.

The Applicant has verified that the dragging body is set into rotation by the motor around said rotation axis is able to displace adhesive resin on the conveying surface from a first region on the conveying surface to a second region on the conveying surface upstream of the first region forming a recirculation zone that keeps the adhesive resin in continuous movement avoiding the formation of stagnation zones. In this way, any impurities are also placed in a state of continuous movement, continuing to recirculate together with the adhesive resin.

The Applicant has also verified that if impurities reach the dragging body, the displacement of adhesive resin actuated by the dragging body can effectively displace these impurities preventing them from being able to compromise the even layer of adhesive resin being formed.

The present invention concerns, in a second aspect thereof, an assembly for preparing a conveying surface to receive a substrate in a printing process.

Preferably, there is provided a conveying surface movable along an advancement direction.

Preferably, there is provided a resin application device in accordance with the first aspect of the present invention and operating on said conveying surface. In a third aspect thereof, the present invention concerns a method of preparing a conveying surface to receive a substrate in a printing process.

Preferably, it is provided to move the conveying surface along an advancement direction.

Preferably, it is provided to deliver adhesive resin at a delivery zone on the conveying surface.

Preferably, it is provided to displace at least part of the adhesive resin from a first region on the conveying surface downstream of the delivery zone to a second region on the conveying surface upstream of the first region.

Preferably, there is provided an even layer of adhesive resin on the conveying surface downstream of the first region.

Preferably displacing at least part of the adhesive resin from the first region to the second region comprises dragging adhesive resin to be displaced towards the second region to form a recirculation zone of adhesive resin between the first region and the second region.

Preferably, the second region on the conveying surface is placed upstream of the first region to form a recirculation zone of adhesive resin between the first region and the second region.

The Applicant has verified that forming the recirculation zone between the first region and the second region keeps the adhesive resin upstream of the even layer formation zone in a state of continuous movement and avoids the formation of stagnation zones. In this way, any impurities are also placed in a state of continuous movement, continuing to recirculate together with the adhesive resin.

The Applicant has further verified that if impurities reach the first region, the displacement of adhesive resin from said first region actuated by dragging the adhesive resin towards a second region can effectively remove such impurities from the first region preventing them from being able to compromise the even layer of adhesive resin being formed.

The present invention concerns, in a fourth aspect thereof, a method of printing a substrate.

Preferably, it is provided to prepare a first conveying surface to receive a substrate according to the method in accordance with the third aspect of the present invention.

Preferably, it is provided to make a substrate adhere onto the first conveying surface.

Preferably, it is provided to transfer printing ink to the substrate in a printing zone. The term “adhesive resin” in the present description and in the subsequent claims means a substance having adhesive properties such that the non-permanent adhesion of a flexible substrate (such as for example a fabric, a plastic film or the like) to the surface of a conveyor belt is allowed. This substance may be active or activatable. When active, this substance has substantially permanently the aforementioned adhesive properties, while when activatable the aforementioned adhesive properties occur only after a predetermined activating event. Such an activating event may for example be the at least partial evaporation of a solvent contained in said substance or the attainment of a predetermined temperature.

This substance is in liquid form with a viscosity greater than 0.01 Pa*s (Pascal per second) measured at 300 K (Kelvin degrees), preferably greater than 0.1 Pa*s (Pascal per second) measured at 300 K (Kelvin degrees), more preferably greater than 1 Pa*s (Pascal per second) measured at 300 K (Kelvin degrees).

The term “to drag” or “dragging” in the present description and in the subsequent claims means the act of carrying, or actively displacing, the adhesive resin conveyed on a conveying surface from a region to a different spatial region by applying a force capable of modifying the state of rest or of motion of the adhesive resin regardless of the motion of the conveying surface.

In the following of the present description and in the subsequent claims, the expressions “downstream” and “upstream” refer to an advancement direction of the conveying surface directed from the adhesive resin dispenser towards the dragging body. Therefore, assuming for example a straight advancement direction from left to right, a “downstream” position with respect to an element or point of reference is any position to the right of said element or point of reference and an “upstream” position with respect to an element or point of reference is any position arranged to the left of said element or point of reference.

The present invention may have, in both aspects discussed above, at least one of the preferred features described below. Such features may thus be present individually or in combination with each other, except where expressly stated otherwise, both in the device of the first aspect of the present invention, and in the assembly of the second aspect of the present invention, and in the method of the third aspect of the present invention, and in the method of the fourth aspect of the present invention.

Preferably, dragging the adhesive resin to be displaced towards the second region comprises exerting on the adhesive resin to be displaced a dragging force having a component directed opposite with respect to the advancement direction.

Preferably, exerting on the adhesive resin to be displaced a dragging force comprises transferring to the adhesive resin an amount of motion having at least one component directed opposite with respect to the advancement direction.

Preferably, dragging the adhesive resin to be displaced towards the second region comprises moving part of the adhesive resin in a direction substantially contrary to the advancement direction of the conveying surface.

Preferably, dragging the adhesive resin to be displaced towards the second region comprises superimposing the dragged adhesive resin on the adhesive resin conveyed by the conveying surface, creating the recirculation zone.

Preferably, the dragged adhesive resin has an amount of motion directed opposite with respect to the adhesive resin conveyed by the conveying surface.

Preferably, displacing at least part of the adhesive resin from the first region to the second region comprises raising adhesive resin from the conveying surface at the first region.

Preferably, displacing at least part of the adhesive resin from the first region to the second region comprises, after raising adhesive resin from the conveying surface, directing raised adhesive resin towards the second region.

Preferably, in the second region the raised adhesive resin is rested on the conveying surface.

Preferably, the adhesive resin being rested on the conveying surface in the second region overlaps the adhesive resin conveyed by the conveying surface.

Preferably, exerting on the adhesive resin to be displaced a dragging force comprises arranging a dragging body in said first region.

Preferably, exerting on the adhesive resin to be displaced a dragging force comprises contacting the adhesive resin with said dragging body and moving said dragging body.

Preferably, the dragging force is transmitted from the dragging body to the adhesive resin.

Preferably, contacting the adhesive resin with said dragging body comprises intercepting the adhesive resin with a dragging surface of the dragging body.

Preferably, intercepting the adhesive resin with a dragging surface of the dragging body comprises at least partially making the adhesive resin adhere onto said dragging surface.

Preferably the adhesive resin adheres to the dragging surface at least in part by effect of the viscosity of the adhesive resin.

Preferably, said dragging surface is smooth.

Preferably, the dragging surface has a surface roughness comprised between 0.2 micron and 25 micron, preferably comprised between 0.4 micron and 15 micron, preferably comprised between 0.6 micron and 5 micron, preferably comprised between 0.7 micron and 1 micron, for example 0.8. Preferably, the dragging body allows to keep the motion of the adhesive resin regular, minimizing its turbulence so as not to compromise the evenness of the resin layer formed downstream.

Preferably, arranging a dragging body in said first region comprises placing said dragging body into contact with the conveying surface.

Preferably, placing said dragging body into contact with the conveying surface comprises regulating a distance between said dragging body and said conveying surface.

Preferably, regulating a distance between said dragging body and said conveying surface comprises guiding a sliding along a first sliding direction of the dragging body with respect to the conveying surface.

Preferably, said first sliding direction is orthogonal to said first conveying surface.

Preferably, it is provided to keep said dragging body in contact with said conveying surface throughout the resin application process.

Preferably, keeping said dragging body in contact with said conveying surface comprises changing a distance between said dragging body and said conveying surface as a result of thickness variations of an evened out resin layer on the conveying surface.

Preferably, keeping said dragging body in contact with said conveying surface comprises moving said dragging body away from said conveying surface by an amount equal to a thickness of the evened out layer of adhesive resin.

Preferably, said conveying surface comprises a possible layer of adhesive resin present on the conveying surface. Preferably, placing said dragging body in contact with the conveying surface comprises placing said dragging body in contact with said layer of adhesive resin.

Preferably, moving said dragging body comprises moving said dragging body with a displacement component directed opposite with respect to the advancement direction.

Preferably, the dragging body drags the adhesive resin in the opposite direction to the advancement direction of the conveying surface.

Preferably, moving said dragging body comprises setting into rotation said dragging body around a rotation axis transverse to the advancement direction.

Preferably, the rotation axis is contained in a plane orthogonal to the advancement direction.

Preferably said dragging body comprises a cylindrical body.

Preferably said rotation axis coincides with an axis of symmetry of the cylindrical body.

Preferably, said dragging surface is cylindrical.

Preferably, moving the conveying surface along an advancement direction comprises rotating a conveyor belt, provided with said conveying surface, in a first angular direction.

Preferably, the conveyor belt is wound on pulleys along a closed path and the first angular direction is referred to the direction of travel of said closed path.

Preferably, said conveying surface is defined by a surface of said conveyor belt.

Preferably, the conveyor belt is wound on the pulleys along a closed path and the first angular direction is referred to the direction of travel of said closed path.

Preferably, rotating said conveyor belt comprises having said conveyor belt make one or more revolutions in said first angular direction.

Preferably setting into rotation said dragging body comprises setting into rotation said dragging body in a second angular direction concordant with the first angular direction.

Preferably, the second angular direction is referred to the rotation direction of the dragging body about the rotation axis.

Preferably the first angular direction and the second direction have a same direction.

Preferably, setting into rotation said dragging body in a second angular direction comprises rotating said dragging body so that the dragging body, at the contact with the conveying surface, has a displacement direction opposite to the advancement direction of the conveying surface.

Preferably, moving said dragging body comprises sliding said dragging body on the conveying surface.

Preferably, the tangential speed of the dragging surface at the contact with the conveying surface is comprised between 0.005 metres/second and 0.25 metres/second, preferably comprised between 0.008 metres/second and 0.18 metres/second, preferably comprised between 0.01 metres/second and 0.13 metres/second, preferably comprised between 0.016 metres/second and 0.08 metres/second, preferably comprised between 0.02 metres/second and 0.05 metres/second.

Preferably, the advancement speed of the conveying surface at the contact with the dragging body is comprised between 0.016 metres/second and 0.45 metres/second, preferably comprised between 0.03 metres/second and 0.30 metres/second, preferably comprised between 0.05 metres/second and 0.15 metres/second, preferably comprised between 0.055 metres/second and 0.13 metres/second, preferably comprised between 0.06 metres/second and 0.1 metres/second.

Preferably, the adhesive resin in the recirculation zone recirculates around a third angular direction.

Preferably, the third angular direction is opposite to the first angular direction.

Preferably, the third angular direction is opposite to the second angular direction.

Preferably, directing raised adhesive resin towards the second region comprises removing adhesive resin from the dragging body and diverting it towards the second region.

Preferably, removing adhesive resin from the dragging body and diverting it towards the second region prevents the adhesive resin contacted by the dragging body and any impurities from remaining attached to the dragging body and from being brought again to the conveying surface by the dragging body itself downstream of an even layer formation zone.

Preferably, removing adhesive resin from the dragging body and diverting it towards the second region comprises arranging a scraper in contact with the dragging surface of the dragging body.

Preferably, removing adhesive resin from the dragging body and diverting it towards the second region comprises preventing at least part of the adhesive resin from passing between the scraper and the dragging body.

Preferably, arranging a scraper in contact with the dragging surface comprises arranging a free edge of the scraper in scraping contact on the dragging surface.

Preferably, removing adhesive resin from the dragging body and diverting it towards the second region comprises withdrawing adhesive resin from the dragging body with a deflection surface of the scraper at the first region.

Preferably, it is provided to keep said scraper in a fixed position with respect to the advancement direction while the conveying surface and the dragging surface are moving.

Preferably, withdrawing adhesive resin from the dragging body with the deflection surface of the scraper comprises orienting said deflection surface obliquely with respect to the conveying surface.

Preferably, orienting said deflection surface obliquely with respect to the conveying surface comprises arranging said deflection surface with an increasing inclination, with respect to the conveying surface, from the free edge in the opposite direction to the advancement direction.

Preferably, orienting said deflection surface obliquely with respect to the conveying surface comprises arranging said deflection surface at an angle with respect to the conveying surface comprised between 1° and 89°, preferably comprised between 15° and 75°, even more preferably comprised between 30° and 60°, for example of about 45°.

Preferably, forming an even layer of adhesive resin on the conveying surface comprises making adhesive resin pass between the conveying body and the conveying surface and spreading with said conveying body the adhesive resin on the conveying surface.

Preferably, the part of adhesive resin dragged from the first region to the second region does not comprise the adhesive resin passing between the dragging body and the conveying surface.

Preferably, the adhesive resin passing between the dragging body and the conveying surface is adhered to the conveying surface before reaching the dragging body.

Preferably, it is provided to form a plurality of even layers of adhesive resin on the conveying surface superimposed on each other.

Preferably, forming a plurality of even layers of adhesive resin on the conveying surface comprises superimposing an even layer of adhesive resin onto one or more even layers of adhesive resin already formed on the conveying surface.

Preferably, an even layer of adhesive resin is formed at each complete rotation of the conveyor belt.

Preferably, for each complete rotation along said first angular direction of the conveyor belt around the pulleys, the thickness of evened out adhesive resin is at least one twentieth of the total thickness of evened out adhesive resin on the conveying surface.

Preferably, it is provided to form overlapping even layers of adhesive resin until reaching a total thickness of evened out adhesive resin on the conveying surface comprised between 0.02 millimetres and 1 millimetres, preferably comprised between 0.05 millimetres and 0.5 millimetres, preferably comprised between 0.1 millimetres and 0.3 millimetres, preferably of about 0.15 millimetres.

Preferably, the thickness of the conveying surface increases as the evened out layers of adhesive resin on the conveying surface increase.

Preferably, spreading with said dragging body the adhesive resin on the conveying surface comprises making the dragging body exert a predetermined pressure on the conveying surface.

Preferably, it is provided to regulate the pressure exerted by the dragging body on the conveying surface.

Preferably, the pressure exerted by the dragging body on the conveying surface is regulated so that the even layer of adhesive resin formed has a pre-established thickness.

Preferably, regulating the pressure exerted by the dragging body on the conveying surface comprises applying at least one compensation force to cancel the pressure exerted by the dragging body on the conveying surface and subsequently applying at least one compressive force to press the dragging body onto the conveying surface with a predetermined pressure.

Preferably, cancelling the pressure exerted by the dragging body on the conveying surface comprises reducing the pressure of the dragging body against the conveying surface due to the weight force acting on the dragging body.

Preferably, the compensation force is directed in a first load direction orthogonal to the conveying surface.

Preferably, the compensation force is directed in a direction coincident with and opposite to a direction of the compressive force.

Preferably, it is provided, after forming an even layer of adhesive resin on the conveying surface downstream of the first region, to move the conveying surface again to the delivery zone and repeat the operations of delivering adhesive resin at the delivery zone on the conveying surface, to displace at least part of the adhesive resin from the first region to the second region and to form an even layer of adhesive resin on the conveying surface downstream of the first region.

Preferably, it is provided to activate the even layer of adhesive resin formed on the conveying surface to make it adhesive.

Preferably, the printing ink is transferred to the substrate by inkjet technology.

Preferably, the printing ink is transferred to the substrate according to a pre-established digital image.

Preferably, it is provided to prepare a second conveying surface to receive a substrate in a printing process.

Preferably, it is provided to move said first conveying surface away from the printing zone when the adhesive resin on said first conveying surface has deteriorated.

Preferably, it is provided to bring said second conveying surface at the printing zone.

Preferably, it is provided to make a substrate adhere onto the second conveying surface and to transfer printing ink to the substrate in the printing zone.

Preferably, it is provided to apply resin on the first conveying surface when the second conveying surface is used in the printing process.

Preferably, the dragging body is in contact with the conveying surface.

Preferably, the conveying surface advances along an advancement direction.

Preferably, said rotation axis of the dragging body is perpendicular to the advancement direction of the conveying surface.

Preferably, the dragging body evens out a layer of adhesive resin on the conveying surface.

Preferably, the dragging body is in contact with the conveying surface along a contact zone that extends over the entire width of the conveying surface.

Preferably, said dragging body has dimensions, in a direction parallel to said rotation axis of the dragging body, at least equal to the dimension of the conveying surface in a direction parallel to the rotation axis of the dragging body.

Preferably, in a contact zone between the dragging body and the conveying surface, the dragging body and the conveying surface have respective advancement directions directed opposite to each other.

Preferably, the conveying surface is defined by a surface of a conveyor belt wound on pulleys configured to rotate the conveyor belt in a first angular direction.

Preferably, the conveyor belt is wound on pulleys along a closed path and the first angular direction is referred to the direction of travel of said closed path.

Preferably, said dragging body rotates about said rotation axis in a second angular direction concordant with said first angular direction.

Preferably, the second angular direction is referred to the rotation direction of the dragging body about the rotation axis.

Preferably the first angular direction and the second direction have a same direction.

Preferably, the dragging body is configured to operate on the adhesive resin delivered on the conveying surface such that part of the adhesive resin is made to adhere from the conveying surface to the dragging body.

Preferably, such adhesion of the adhesive resin from the conveying surface to the dragging body is actuated by effect of the rotation of the dragging body and of the viscosity of the adhesive resin.

Preferably, the part of adhesive resin adhering to the dragging body does not comprise the adhesive resin being evened out by the dragging body on the conveying surface.

Preferably, the adhesive resin that is evened out by the dragging body on the conveying surface is a resin layer in direct contact with the conveying surface.

Preferably, the total layer of adhesive resin has a thickness comprised between 0.02 millimetres and 1 millimetres, preferably comprised between 0.05 millimetres and 0.5 millimetres, preferably comprised between 0.1 millimetres and 0.3 millimetres, preferably of about 0.15 millimetres.

Preferably, there is provided a scraper placed in contact with said dragging body.

Preferably, the scraper is configured to remove at least part of the adhesive resin from said dragging body.

Preferably, the scraper is fixedly mounted on said support frame in a position interposed between said rotation axis of the dragging body and said dispenser.

Preferably, the scraper is placed downstream of the dispenser and operates directly on the dragging body.

Preferably, the scraper is configured to direct the adhesive resin removed from the dragging body towards a zone placed upstream of the scraper.

Preferably, the dragging body is a cylindrical body.

Preferably, the dragging body comprises a dragging surface.

Preferably, the dragging surface is an outer surface of the dragging body.

Preferably, the dragging surface is a cylindrical surface.

Preferably, the cylindrical shape of the dragging surface creates, in proximity to the dragging surface, a tapered channel that favours the evening out of the layer of adhesive resin actuated by the dragging body.

Preferably, the dragging surface of the dragging body is in direct contact with the conveying surface.

Preferably, in a contact zone between the dragging body and the conveying surface, the conveying surface of the dragging body has a tangential speed directed opposite with respect to an advancement speed of the conveying surface.

Preferably, the tangential speed of the dragging surface is comprised between 0.005 metres/second and 0.25 metres/second, preferably comprised between 0.008 metres/second and 0.18 metres/second, preferably comprised between 0.01 metres/second and 0.13 metres/second, preferably comprised between 0.016 metres/second and 0.08 metres/second, preferably comprised between 0.02 metres/second and 0.05 metres/second.

Preferably, the advancement speed of the conveying surface is comprised between 0.016 metres/second and 0.45 metres/second, preferably comprised between 0.03 metres/second and 0.30 metres/second, preferably comprised between 0.05 metres/second and 0.15 metres/second, preferably comprised between 0.055 metres/second and 0.13 metres/second, preferably comprised between 0.06 metres/second and 0.1 metres/second.

Preferably, said dragging surface is smooth. Preferably, the dragging surface has a surface roughness comprised between 0.2 micron and 25 micron, preferably comprised between 0.4 micron and 15 micron, preferably comprised between 0.6 micron and 5 micron, preferably comprised between 0.7 micron and 1 micron, for example 0.8 micron.

The Applicant believes that these roughness values allow an effective dragging of the resin by the dragging body and allow to adequately even out the resin layer.

Preferably, the scraper comprises a free edge in scraping contact on the dragging surface of said dragging body.

Preferably, the free edge of the scraper removes adhesive resin from the dragging surface of the dragging body.

Preferably, the scraper comprises a deflection surface configured to direct the adhesive resin removed from the dragging body towards a zone placed upstream of the dragging body.

Preferably, the deflection surface develops starting from said free edge and away from said free edge.

Preferably, the scraper has an extension in a direction parallel to said rotation axis at least equal to an extension in the same direction as the dragging body.

Preferably, the dragging body is mounted on said support frame so as to be able to move the dragging body away from and towards the conveying surface.

Preferably, at each complete rotation along said first angular direction of the conveyor belt around the pulleys, the dragging body evens out a layer of adhesive resin on the conveying surface.

Preferably, for each complete rotation along said first angular direction of the conveyor belt around the pulleys, the thickness of evened out adhesive resin is at least one twentieth of the total thickness of evened out adhesive resin on the conveying surface.

Preferably, successive and overlapping layers of adhesive resin are evened out on the conveying surface during complete rotations of the conveyor belt around the pulleys.

Preferably, the thickness of the conveying surface increases as the evened out layers of adhesive resin on the conveying surface increase.

Preferably, the dragging body is mounted on said support frame so as to exert a predetermined pressure on the conveying surface.

Preferably, the dragging body is mounted on said support frame so as to be able to vary its distance from the conveying surface.

Preferably, at each complete rotation along said first angular direction of the conveyor belt around the pulleys, the dragging body is moved away from the conveying surface by a predetermined distance.

Preferably, said predetermined distance is about equal to the thickness of adhesive resin evened out on the conveying surface, so that the dragging body is always in contact with the conveying surface.

Preferably, said support frame comprises at least a first portion stably constrainable to the frame of the conveyor belt.

Preferably, said support frame comprises a second portion coupled to said at least one first portion.

Preferably, said second portion is movably coupled to said at least one first portion to vary the relative distance between said at least one first portion and said second portion.

Preferably, said second portion is movably coupled to said at least one first portion to vary the inclination of the rotation axis of the dragging body.

Preferably, said dragging body is rotatably mounted on said second portion.

Preferably, said dispenser is mounted on said second portion.

Preferably, said second portion extends transversely from a first end to a second end.

Preferably, the distance between said first end and said second end is greater than the transverse dimension of said conveying surface.

Preferably, said at least one first portion comprises a first fixing body configured to be constrained to the frame of the conveyor belt.

Preferably, a further first portion comprises a second fixing body configured to be constrained to the frame of the conveyor belt.

Preferably, the first fixing body and the second fixing body are constrained to transversely opposite portions of the frame of the conveyor belt.

Preferably, said support frame comprises at least one guide mechanism interposed between the at least a first portion and the second portion of the support frame.

Preferably, said at least one guide mechanism is interposed between the first fixing body and the first end of the second portion of the support frame.

Preferably, said at least one guide mechanism is configured to guide a sliding of the second portion of the support frame with respect to the first portion of the support frame along a first sliding direction.

Preferably, the first sliding direction is orthogonal to the conveying surface.

Preferably, said at least one guide mechanism is configured to guide a displacement of said dragging body parallel to the first sliding direction.

Preferably, said displacement of the dragging body allows said dragging body to be kept in contact with the conveying surface during a variation in thickness of the conveying surface.

Preferably, said support frame comprises a further guide mechanism interposed between the at least one first portion of the support frame and the second portion of the support frame.

Preferably, the further guide mechanism is configured to be arranged laterally to the conveyor belt opposite with respect to the at least one guide mechanism.

Preferably, said further guide mechanism is interposed between the second fixing body and the second end of the second portion of the support frame.

Preferably, said further guide mechanism is configured to guide a sliding of the second portion with respect to the first portion along a second sliding direction.

Preferably, the second sliding direction is parallel to the first sliding direction.

Preferably, the second sliding direction is orthogonal to the conveying surface.

Preferably, said further guide mechanism is configured to guide a displacement of said dragging body parallel to the second sliding direction.

Preferably, the further guide mechanism in combination with the at least one guide mechanism allow for parallel translation of the dragging body with respect to the conveying surface when the sliding along the first sliding direction and along the second sliding direction of the second portion of the support frame with respect to the first portion of the support frame have the same extent.

Preferably, the further guide mechanism in combination with the at least one guide mechanism allow tilting the rotation axis of the dragging body with respect to the conveying surface when the sliding along the first sliding direction and along the second sliding direction of the second portion of the support frame with respect to the first portion of the support frame have different extent.

Preferably, said support frame further comprises at least one active load regulator between the at least a first portion of the support frame and the second portion of the support frame.

Preferably, said at least one load regulator is active between the first fixing body and the first end of the second portion of the support frame.

Preferably, said at least one load regulator is configured to selectively regulate a pressure that the dragging body exerts against the conveying surface along a first load direction.

Preferably, the first load direction is perpendicular to the conveying surface.

Preferably, the first load direction is perpendicular to the advancement direction of the conveying surface.

Preferably, the first load direction is parallel and preferably coincident with the first sliding direction.

Preferably, said at least one load regulator comprises a first compensator configured to exert a compensation force on the second portion directed away with respect to the at least one first portion.

Preferably said first compensator is configured to selectively vary the modulus of said compensation force.

Preferably, said first compensator is configured to counteract at least the weight force that said dragging body exerts on the conveying surface.

Preferably, said first compensator is configured to counteract the weight force that said dragging body and said second portion of the support frame exert on the conveying surface.

Preferably, said compensation force is opposite to the weight force exerted by the dragging body and by the second portion of the support frame on the conveying surface.

Preferably, said first compensator is configured to cancel the weight force that said dragging body and said second portion of the support frame exert on the conveying surface.

Preferably said first compensator comprises an elastic member configured to exert said compensation force on said second portion.

Preferably, said at least one load regulator further comprises a first pressor configured to exert a compressive force on the second portion of the support frame directed towards the at least a first portion of the support frame.

Preferably said first pressor is configured to selectively vary the modulus of said compressive force.

Preferably, said first pressor is configured to increase the pressure that said dragging body exerts on the conveying surface.

Preferably, said compressive force is concordant with the weight force exerted by the dragging body on the conveying surface.

Preferably said first pressor comprises an elastic member configured to exert said compressive force on said second portion of the support frame.

Preferably, to selectively regulate the pressure that the dragging body exerts against the conveying surface along the first load direction, the first compensator is configured so as to cancel the weight force exerted by the dragging body and by the second portion of the support frame on the conveying surface and subsequently the first pressor is configured so as to exert said compressive force in order to achieve a desired pressure of the dragging body on the conveying surface.

Preferably, said at least one load regulator comprises a second compensator configured to exert a compensation force on the second portion of the support frame directed away from the at least a first portion of the support frame.

Preferably, the second compensator is offset with respect to the first compensator along said advancement direction.

Preferably, the second compensator is substantially structurally identical to the first compensator and performs substantially the same functions as the first compensator.

Preferably, said at least one load regulator further comprises a second pressor configured to exert a compressive force on the second portion of the support frame directed towards the at least a first portion of the support frame.

Preferably, the second pressor is offset with respect to the first pressor along said advancement direction.

Preferably, the second pressor is substantially structurally identical to the first pressor and performs substantially the same functions as the first pressor.

The Applicant believes that the second compensator and the second pressor allow to distribute more evenly the compensation forces and the compressive forces acting between the at least a first portion of the support frame and said second portion of the support frame.

Preferably, said support frame comprises a further active load regulator between the further first portion of the support frame and the second portion of the support frame.

Preferably, said further load regulator is active between the second fixing body and the second end of the second portion of the support frame.

Preferably, said further load regulator is substantially structurally identical to the at least one load regulator and performs substantially the same functions as the at least one load regulator.

The Applicant believes that the further load regulator in combination with the at least one load regulator allows to distribute the compensation forces and the compressive forces acting between the at least a first portion of the support frame and said second portion of the support frame so that the dragging body exerts an even pressure along its entire development on the conveying surface.

Preferably, said conveyor belt is mounted on a frame configured to be associated with an inkjet printer.

### BRIEF DESCRIPTION OF THE DRAWINGS

Further characteristics and advantages of the present invention will become clearer from the following detailed description of a preferred embodiment thereof, with reference to the appended drawings and provided by way of indicative and non-limiting example, in which:

FIG. 1 is a side schematic view of an assembly for preparing a conveying surface to receive a substrate in a printing process in accordance with the present invention;

FIG. 2 is a side view of a resin application device for a conveying surface in a printing process in accordance with the present invention;

FIG. 3 is a sectional side view of a resin application device for a conveying surface in a printing process in accordance with the present invention;

FIG. 4 is a front schematic view of a resin application device for a conveying surface in a printing process in accordance with the present invention;

FIG. 5 is a schematic sectional view of an operational configuration of a resin application device for a conveying surface in a printing process in accordance with the present invention.

### DETAILED DESCRIPTION OF THE DRAWINGS

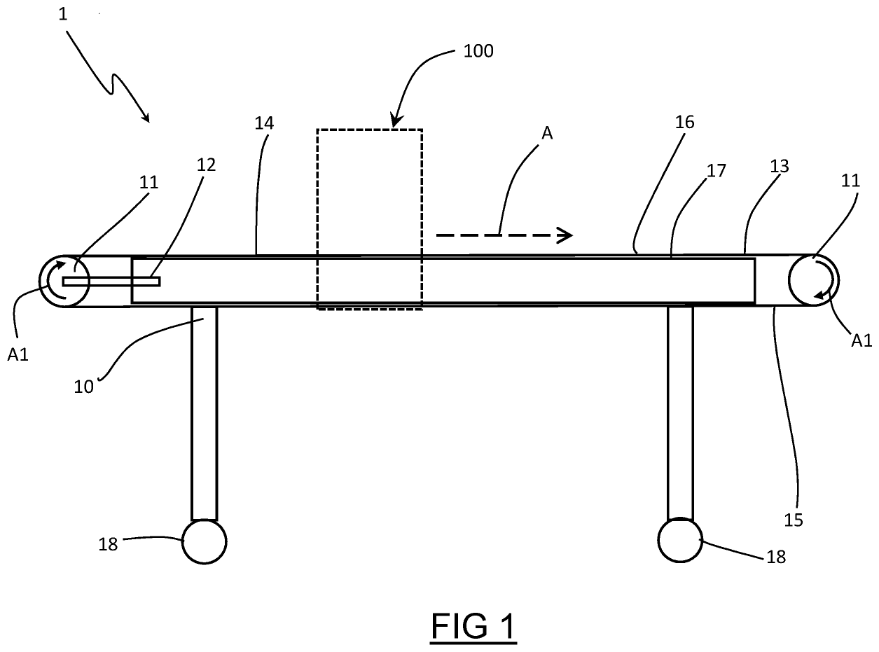

An assembly for preparing a conveying surface to receive a substrate in a printing process in accordance with the present invention is indicated by the numerical reference 1 in FIG. 1.

The assembly 1 comprises a frame 10 and a plurality of pulleys 11 mounted on the frame 10. The plurality of pulleys 11 comprise at least two pulleys 11, placed at respective opposite ends of the frame 10. A tensioner 12 is configured to regulate the mutual distance between the pulleys 11.

A conveyor belt 13 is wound on the plurality of pulleys 11 along a closed path.

The conveyor belt 13 comprises a band preferably made of elastomeric material, closed on itself around the plurality of pulleys 11. The tensioning member 12 is configured to keep the conveyor belt 13 tensioned according to a pre-established tension.

The conveyor belt 13 during its rotation defines an upper branch 14 and a lower branch 15, extended parallel between the two pulleys 11. A conveying surface 16 is defined on the upper branch 14. This conveying surface 16 faces upwards.

The frame 10 comprises an abutment surface 17 on which the upper branch 14 slidingly rests. The abutment surface 17 is configured to keep the conveying surface 16 in a planar configuration while the upper branch 14 slides on the abutment surface 17.

At least one of the pulleys 11 is motorized and configured to rotate the conveyor belt 13 in a first angular direction A1. Such rotation in the first angular direction A1 defines an advancement direction A for the conveying surface 16 along the upper branch 14 of the conveyor belt. This rotation in the first angular direction A1 defines, for the lower branch 15 of the conveyor belt 13, an advancement direction opposite to the advancement direction A.

The pulleys 11 are configured to move the conveying surface 16 in the advancement direction A with an advancement speed with respect to the frame 10 comprised between 0.016 metres/second and 0.45 metres/second.

The frame 10 can be associated with an inkjet printer, not illustrated in the accompanying figures, so that the conveying surface 16 advances in the advancement direction A at the printhead of the printer. For example, the frame 10 may be configured to be removably constrained to the printer.

The conveying surface 16 is configured to receive a substrate, not illustrated, and convey it along the advancement direction A.

This substrate is typically made of flexible material adapted to receive the printing ink delivered by the printer. The substrate may be a fabric, a film made of a plastic material, and the like.

The conveying surface 16 has the function of retaining the substrate flat without the latter being able to move or displace itself with respect to the conveying surface 16 during the printing process.

The assembly 1 may comprise movement members 18, for example wheels, configured to allow the movement of the frame 10 on a floor. In this way it is possible to disassociate the frame 10 from the printer and move it away therefrom.

The assembly 1 further comprises a resin application device for a conveying surface in a printing process, illustrated by the numerical reference 100 in the accompanying figures.

The resin application device 100 comprises a support frame 101 configured to be mounted on the frame 10 of the conveyor belt 13. The support frame 101 is mountable and dismountable from the frame 10 of the conveyor belt 13.

The resin application device 100 is mounted transversely on the conveyor belt 13 with respect to the advancement direction A.

The resin application device 100 may be installed on the conveyor belt 13 when the latter is disassociated from the inkjet printer and uninstalled from the conveyor belt 13 to associate the latter with the inkjet printer.

The support frame 101 comprises a first portion 102 stably constrainable to the frame 10 of the conveyor belt 13. The first portion 102 comprises a first fixing body 103 fixable to a side portion of the frame 10 of the conveyor belt 13, for example by means of fixing members such as screws and/or bolts (not illustrated).

The support frame 101 comprises a further first portion 104 analogous to the first portion 102. The further first portion 104 comprises a second fixing body 105 fixable to a side portion of the frame 10 on the opposite side, in a direction transverse to the advancement direction A, to the first fixing body 103, for example by means of fixing members such as screws and/or bolts (not illustrated).

The support frame 101 comprises a second portion 106 extended between the first portion 102 and the further first portion 104. The second portion 106 is extended transversely from a first end 107 to a second end 108. When the device 100 is installed on the conveyor belt 13, the second portion 106 is arranged orthogonal to the advancement direction A. The distance between the first end 107 and the second end 108 is greater than the transverse dimension of the conveying surface 16, with respect to the advancement direction A.

The second portion 106 comprises a first vertical element 109 placed at the first end 107 and a second vertical element 110 placed at the second end 108. The second portion 106 further comprises two horizontal elements 111 extended parallel to each other between the first vertical element 110 and the second vertical element 112. The horizontal elements 111 may be in a number other than two, for example more than two or one.

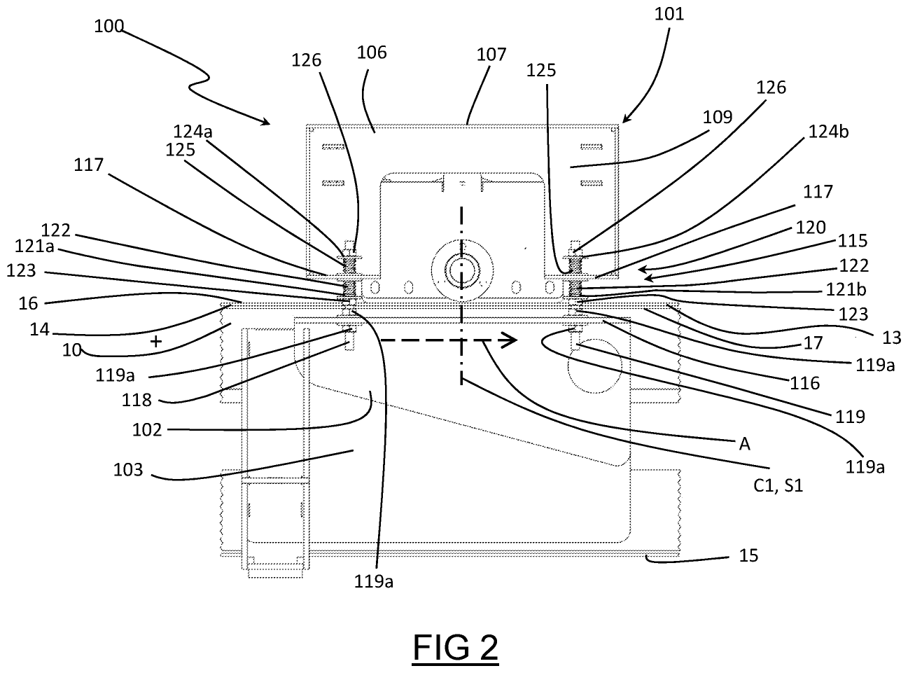

A guide mechanism 115, illustrated in FIG. 2, is interposed between the first portion 102 and the second portion 106 to connect them allowing a mutual movement thereof.

The guide mechanism 115 is connected to the first fixing body 103 of the first portion 102 at a lower flange 116. The lower flange 116 is fixed to the first fixing body 103.

The guide mechanism 115 is connected to the second portion 106, at the first end 107, by upper flanges 117. The upper flanges 117 are obtained on the first vertical element 109.

The guide mechanism 115 is configured to allow a sliding of the second portion 106 with respect to the first portion 102 along a first sliding direction S1.

When the device 100 is installed on the conveyor belt 13, the first sliding direction S1 is orthogonal to the conveying surface 16.

The guide mechanism 115 comprises a first stem 118 and a second stem 119.

The stems 118, 119 are extended parallel to the first sliding direction S1 from the first portion 102 to the second portion 106. The stems 118, 119 are externally threaded.

The first stem 118 and the second stem 119 are spaced apart from each other parallel to the advancement direction A.

In the illustrated embodiment, each stem 118, 119 is rigidly fixed to the first portion 102, in particular to the lower flange thereof 116. Each stem 118, 119 passes through a respective hole obtained in the lower flange 116 and a pair of locking members 119a engages each stem 118, 119 on opposite sides of the lower flange 116 to tighten the respective stem 118, 119 to the lower flange 116.

The locking members 119a comprise for example nuts screwed onto the stem to tighten the lower flange 116 and possibly provided with respective washers or, in an embodiment not illustrated, the locking members 119a may comprise a head integral with the respective stem 118, 119 (in otherwords the stem 118, 119 could be the stem of a bolt having a head).

In one embodiment not illustrated, one or both of the stems 118, 119 may be rigidly fixed to the second portion 106 and may slide into respective holes made in the first portion 102.

The second portion 106 of the support frame 101 is floating along the first stem 118 and the second stem 119 along the first sliding direction S1. The first stem 118 and the second stem 119 slidingly pass through respective holes obtained in the upper flanges 117 so as to allow the second portion 106 to slide with respect to the first stem 118 and to the second stem 119 along the first sliding direction S1.

A load regulator 120, illustrated in FIG. 2, is active between the first portion 102 and the second portion 106 of the support frame 101 to exert an adjustable force on the second portion 106 of the support frame 101 along a first load direction C1.

The first load direction C1 is coincident with the first sliding direction S1. When the device 100 is installed on the conveyor belt 13, the first load direction C1 is orthogonal to the conveying surface 16.

The load regulator 120 is configured to increase and decrease the pressure that a dragging device 150 (described below) exerts on the conveyor surface 16 when the device 100 is installed on the conveyor belt 13.

The load regulator 120 is placed at the upper flanges 117 of the second portion 106 of the support frame 101 to directly exert the adjustable force thereon.

The load regulator 120 comprises a first compensator 121a and a second compensator 121b. The first compensator 121a and the second compensator 121b each comprise an elastic member 122 arranged in abutment against the respective upper flange 117 so as to exert on the second portion 106 an elastic force directed parallel to the first load direction C1 on the opposite side with respect to the first portion 102. This elastic force tends to move the first portion 102 and the second portion 106 of the support frame 101 away from each other in a direction perpendicular to the conveying direction A.

In the illustrated preferred embodiment, the elastic member 122 of the first compensator 121a comprises a metal spring, wound around the first stem 118 and in abutment on the respective upper flange 117. Similarly, the elastic member 122 of the second compensator 121b comprises a metal spring, wound around the second stem 119 and in abutment on the respective upper flange 117.

The first compensator 121a and the second compensator 121b each comprise a load adjuster 123 configured to selectively regulate the elastic force of the respective elastic member 122. The load adjusters 123 are active on the elastic members 121 to compress them towards the second portion 106 of the support frame.

In the illustrated preferred embodiment, the load adjuster 123 of the first compensator 121a is installed in an adjustable position along the first stem 118 in abutment against the respective elastic member 122. Similarly, the load adjuster 123 of the second compensator 121b is installed in an adjustable position along the second stem 119 in abutment against the respective elastic member 122.

By regulating the position of the load adjusters 123 along the respective stems 118, 119 it is possible to regulate the elastic force of the elastic members 123 and to consequently regulate the distance of mutual away-movement between the lower flange 116 and the upper flange 117. In addition, the load adjusters 123 may define respective end stops that determine a maximum allowed distance between the lower flange 116 and the upper flange 117.

In the illustrated preferred embodiment, the load adjusters 123 of the first compensator 121a and of the second compensator 121b each comprise a nut screwed onto the respective stem 118, 119.

The load regulator 120 further comprises a first pressor 124a and a second pressor 124b. The first pressor 124a and the second pressor 124b each comprise an elastic member 125 arranged in abutment against the respective upper flange 117 so as to exert on the second portion 106 an elastic force directed parallel to the first load direction C1 towards the first portion 102.

The elastic members 125 of the loading members 124a, 124b abut on the respective upper flanges 117 on opposite sides with respect to the elastic members 122 of the first and second compensators 121a, 121b.

In the illustrated preferred embodiment, the elastic member 125 of the first pressor 124a comprises a metal spring wound around the first stem 118 and in abutment on the respective upper flange 117. Similarly, the elastic member 125 of the second compensator 124b comprises a metal spring wound around the second stem 119 and in abutment on the respective upper flange 117.

The first pressor 124a and the second pressor 124b each comprise a load adjuster 126 configured to regulate the elastic force of the respective elastic member 125. The load adjusters 126 are active on the elastic members 121 to compress them towards the first portion 102 of the support frame 101.

In the preferred embodiment, the load adjuster 126 of the first pressor 124a is installed in an adjustable position along the first stem 118 in abutment against the respective elastic member 125. Similarly, the load adjuster 126 of the second pressor 124b is installed in an adjustable position along the second stem 119 in abutment against the respective elastic member 125.

By regulating the position of the load adjusters 126 along the respective stems 118, 119 it is possible to regulate the preload of the elastic members 125 and to consequently regulate the distance of mutual approach between the upper flange 117 and the lower flange 116. In addition, the load adjusters 126 may define respective end stops that determine a minimum allowed distance between the lower flange 116 and the upper flange 117.

In the illustrated preferred embodiment, the load adjusters 126 of the first pressor 124a and of the second pressor 124b each comprise a nut screwed onto the respective stem 118, 119.

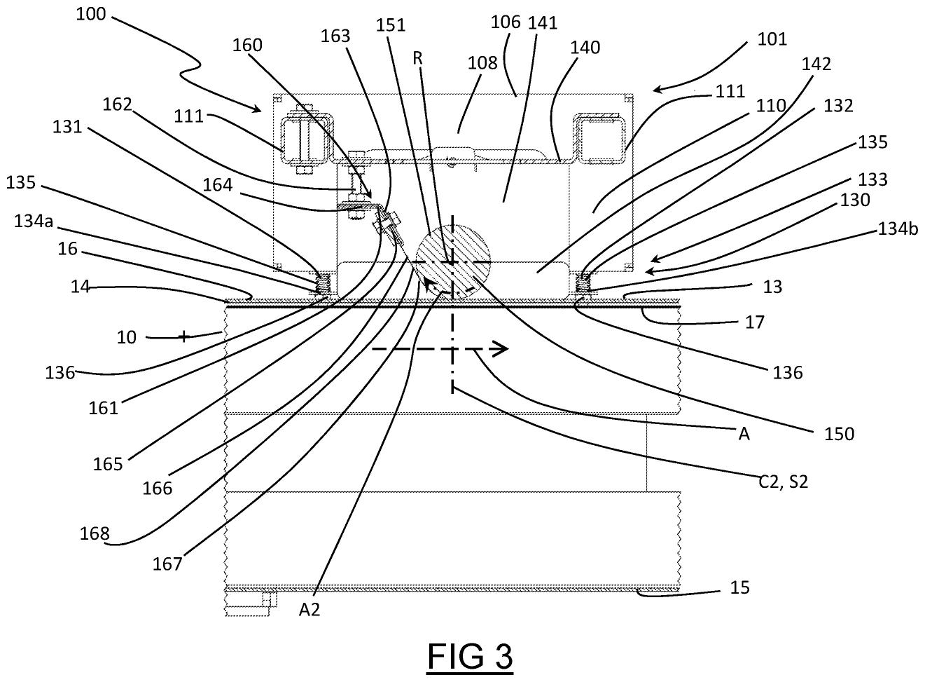

A further guide mechanism 130, partially illustrated in FIG. 3, is interposed between the further first portion 104 and the second portion 106 to connect them allowing a mutual movement thereof.

Similar to the guide mechanism 115 described above, the further guide mechanism 130 is connected to the second fixing body 105 of the first portion 102 of the support frame 101 at a lower flange (not represented in the accompanying figures) fixed to the second fixing body 105.

The further guide mechanism 130 is connected to the second portion 106 of the support frame 101 at the upper flanges (not represented in the accompanying figures) obtained on the second vertical element 110.

When the device 100 is installed on the conveyor belt 13, the further guide mechanism 130 is arranged opposite the guide mechanism 115 with respect to a transverse direction of the conveyor belt 13.

Similar to the guide mechanism 115, the further guide mechanism 130 is configured to allow a sliding of the second portion 106 with respect to the first portion 102 along a second sliding direction S2. The second sliding direction S2 is parallel to the first sliding direction S1.

Similar to the guide mechanism 115, the further guide mechanism 130 comprises a third stem 131 and a fourth stem 132. The stems 131, 132 are extended parallel to the second sliding direction S2 from the first portion 102 to the second portion 106. The stems 131, 132 are externally threaded.

The third stem 131 and the fourth stem 132 are spaced apart from each other parallel to the advancement direction A and are spaced apart from the first stem 118 and from the second stem 119 transversely to the advancement direction A.

In the illustrated embodiment, each stem 131, 132 is rigidly fixed to the further first portion 104, in particular to the lower flange thereof. Each stem 131, 132 passes through a respective hole obtained in the lower flange and a pair of locking members (not illustrated) engages each stem 131, 132 on opposite sides of the lower flange to tighten the respective stem 131, 132 to the lower flange.

The locking members comprise for example nuts screwed onto the respective stem 131, 132 to tighten the lower flange and possibly provided with respective washers or, in an embodiment not illustrated, the locking members may comprise a head integral with the respective stem 131, 132 (in other words the stem 131 or 132 could be the stem of a bolt having a head).

In embodiments not illustrated, one or both of the stems 131, 132 may be rigidly fixed to the second portion 106 and may slide into respective holes made in the further first portion 104.

The second portion 106 of the support frame 101 is floating along the third stem 131 and the fourth stem 132 along the second sliding direction S2. The third stem 131 and the fourth stem 132 slidingly pass through respective holes obtained in the upper flanges so as to allow the second portion 106 to slide with respect to the third stem 131 and to the fourth stem 132 along the second sliding direction S2.

A further load regulator 133, partially illustrated in FIG. 3, is active between the further first portion 104 and the second portion 106 of the support frame 101 to exert an adjustable force on the second portion 106 of the support frame 101 along a second load direction C2.

The second load direction C2 is coincident with the second sliding direction S2. When the device 100 is installed on the conveyor belt 13, the second load direction C2 is orthogonal to the conveying surface 16.

The further load regulator 133 cooperates with the load regulator 120 to increase and decrease the pressure that the dragging device 150 (described below) exerts on the conveying surface 16 when the device 100 is installed on the conveyor belt 13.

The further load regulator 133 is placed at the upperflanges of the second portion 106 of the support frame 101 to directly exert the adjustable force thereon.

The further load regulator 133 comprises a third compensator 134a and a fourth compensator 134b that are analogous to the first compensator 121a and to the second compensator 121b. The third compensator 134a and the fourth compensator 134b each comprise an elastic member 135 arranged in abutment against the respective upper flange so as to exert on the second portion an elastic force directed parallel to the second load direction C2 on the opposite side with respect to the first portion 102.

In the illustrated preferred embodiment, the elastic member 135 of the third compensator 134a comprises a metal spring wound around the third stem 131 and in abutment on the respective upper flange. Similarly, the elastic member 135 of the fourth compensator 134b comprises a metal spring wound around the fourth stem 132 and in abutment on the respective upper flange.

The third compensator 134a and the fourth compensator 134b each comprise a load adjuster 136 configured to selectively regulate the elastic force of the respective elastic member 135. The load adjusters 136 are active on the elastic members 135 to compress them towards the second portion 106 of the support frame.

In the illustrated preferred embodiment, the load adjuster 136 of the third compensator 134a is installed in an adjustable position along the third stem 131 in abutment against the respective elastic member 135. Similarly, the load adjuster 136 of the second compensator 134b is installed in an adjustable position along the fourth stem 132 in abutment against the respective elastic member 135.

By regulating the position of the load adjusters 136 along the respective stems 131, 132 it is possible to regulate the elastic force of the elastic members 136 and to consequently regulate the distance of mutual away-movement between the lower flange and the upper flange. In addition, the load adjusters 136 may define respective end stops that determine a maximum allowed distance between the lower flange and the upper flange.

In the illustrated preferred embodiment, the load adjusters 136 of the third compensator 134a and of the fourth compensator 134b each comprise a nut screwed onto the respective stem 131, 132.

The further load regulator 133 further comprises a third pressor and a fourth pressor, which are analogous to the first pressor 124a and to the second pressor 124b and not visible in the accompanying figures. The third pressor and the fourth pressor each comprise an elastic member arranged in abutment against the respective upper flange so as to exert on the second portion an elastic force directed parallel to the second load direction C2 towards the first portion 102.

The elastic members of the third and fourth pressor are in abutment on the respective upper flanges on opposite sides with respect to the elastic members 136 of the third and fourth compensator 134a, 134b.

In the illustrated preferred embodiment, the elastic member of the third pressor comprises a metal spring wound around the third stem 131 and in abutment on the respective upper flange. Similarly, the elastic member of the fourth compensator comprises a metal spring wound around the fourth stem 132 and in abutment on the respective upper flange.

The third pressor and the fourth pressor each comprise a load adjuster, not visible in the accompanying figures, configured to regulate the elastic force of the respective elastic member. The load adjusters of the third pressor and fourth pressor are active on the elastic members to compress them towards the first portion 102 of the support frame 101.

In the preferred embodiment, the load adjuster of the third pressor is installed in an adjustable position along the third stem 131 in abutment against the respective elastic member. Similarly, the load adjuster of the fourth pressor is installed in an adjustable position along the fourth stem 132 in abutment against the respective elastic member.

By regulating the position of the load adjusters on the respective stems 131, 132 it is possible to regulate the preload of the elastic members and to consequently regulate the distance of mutual approach between the lower flange and the upper flange. In addition, the load adjusters of the third pressor and of the fourth pressor may define respective end stops that determine a minimum allowed distance between the lower flange and the upper flange.

In the illustrated preferred embodiment, the load adjusters of the third pressor and of the fourth pressor each comprise a nut screwed onto the respective stem 131, 132.

The support frame 101 comprises a support body 140 mounted on the second portion 106. The support body 140 is fixed to the horizontal elements 111.

The support body 140 comprises two side bulkheads 141 projecting towards the conveying surface 16. The side bulkheads 141 are preferably parallel to each other. An end portion 142 of each side bulkhead 141 is height adjustable so that it can contact the conveying surface 16.

The dragging body 150 is mounted on the second portion of the support frame 101 and is rotatable with respect to the latter about a rotation axis R.

In the preferred embodiment, the dragging body 150 is mounted on the support body 140 so as to be in contact with the conveying surface 16 when the resin application device 10 is mounted on the conveyor belt 13. The dragging body 150 is rotatably mounted between the side bulkheads 141 of the support body 140.

The dragging body 150 develops between the side bulkheads 141 substantially over the entire distance separating the two side bulkheads 141.

When the resin application device 100 is mounted on the conveyor belt 13, the rotation axis R of the dragging body 150 is orthogonal to the advancement direction A. The rotation axis R of the dragging body 150 is orthogonal to the first load direction C1 and to the second load direction C2 and is contained in a plane containing both the first load direction C1 and the second load direction C2.

Similarly, the rotation axis R of the dragging body 150 is orthogonal to the first sliding direction S1 and to the second sliding direction S2 and is contained in a plane containing both the first sliding direction S1 and the second sliding direction S2.

The dragging body 150 has an extension along the rotation axis R equal to or greater than the width of the conveyor belt 13 measured perpendicular to the advancement direction A.

In the illustrated embodiment, the dragging body 150 is a cylindrical body and defines a cylindrical dragging surface 151 at the outer surface thereof. The dragging body 150 has an axis of symmetry coincident with the rotation axis R.

In other words, the dragging body 150 is a roller.

The dragging surface 151 is free of protuberances or indentations and has a surface roughness comprised between 0.2 microns to 25 microns, for example 0.8.

The guide mechanisms 115, 130 allow the dragging surface 151 to be brought to rest on the conveying surface 16.

By acting on the load regulators 120, 133 it is possible to regulate the pressure that the dragging surface 151 exerts on the conveying surface 16.

By acting on the load adjusters of the compensators 121a, 121b, 134a, 134b, it is possible to exert elastic forces on the second portion 106 of the support frame 101 so as to decrease the pressure of the dragging surface 151 on the conveying surface 16 until it is cancelled out.

By acting on the load adjusters of the pressors 124a, 124b it is possible to exert elastic forces on the second portion 106 of the support frame 101 so as to increase the pressure that the dragging surface 151 exerts on the conveying surface 16.

In this way, the regulation of the pressure that the dragging body 150 exerts on the conveying surface 16 can be actuated firstly by substantially bringing this pressure to zero and, subsequently) by progressively increasing the pressure up to the desired value.

By regulating the load adjusters of the load regulator 120 and of the further load regulator 133 differently, it is possible to vary the distribution along the rotation axis R of the pressure that the dragging surface 151 exerts on the conveying surface 16.

When the dragging body 150 is resting on the conveying surface 16, the sliding mechanisms 115, 130 allow to compensate for any changes in the thickness of the conveyor belt 13, by changing the position of the dragging body 150 so as to maintain the contact between the dragging surface 151 and the conveying surface 16 and a substantially constant pressure therebetween.

Such thickness changes may for example be due to the increased thickness of the resin layer on the conveying surface 16 during resin application (as will be better described below).

A motor 155 is connected to the dragging body 150 for setting into rotation the dragging body 150 about the rotation axis R. In the illustrated embodiment, the motor 155, of the electric type, is fixed to a side bulkhead 151 of the support body 140 and is connected to the dragging body 150 by means of a shaft (not illustrated) engaging a hole (not illustrated) of the side bulkhead 141.

The motor 155 is configured to rotate the dragging body 150 in a second angular direction A2 concordant with the first angular rotation direction A1 of the conveyor belt 13. The first angular direction A1 and the second angular direction A2 have the same rotation direction. In this way, in a contact zone 156 between the dragging body 150 and the conveying surface 16, the conveying surface 151 of the dragging body 150 has a tangential speed directed opposite with respect to the advancement speed of the conveying surface 16, directed in the advancement direction A. The different directions between the advancement speed A of the conveying surface 16 and the tangential speed of the conveying surface 151 at the contact zone 156 with the conveying surface 16 cause a scraping or sliding of the conveying surface 151 on the conveying surface 16.

The motor 155 is configured to rotate the dragging body 150 so as to obtain a tangential speed of the dragging surface 151 comprised between 0.005 metres/second and 0.25 metres/second.

A scraper 160, shown in section in FIG. 3, is mounted on the support frame 101 and placed in contact with the dragging surface 151 of the dragging body 150.

The scraper 160 is mounted upstream of the dragging body 150 with respect to the advancement direction A of the conveyor belt 13.

The scraper 160 comprises a mounting body 161 fixed to the second portion 106 of the support frame, preferably to the support body 140. The mounting body 161 is mounted on the support body 140 through adjusting members 162 so as to allow regulating the position of the scraper 160 towards and away from the conveying surface 16. The adjusting members 162 comprise bolts and nuts tightened on the mounting body 140 and on the support body 161, possibly provided with respective washers.

The mounting body 161 comprises a lamellar body 163 which is bent so as to have a horizontal part 164, parallel to the conveying surface 16, and an oblique part 165, projecting obliquely with respect to the conveying surface 16 towards the dragging body 150.

A scraping blade 166 is fixed to the mounting body 161 and extends from the mounting body 161 to the dragging surface 151 of the dragging body 150 in a plane oblique with respect to the conveying surface 16. The scraping blade 166 is fixed to the oblique portion 165.

The scraper 160 extends along the entire transverse extension of the dragging body 150, preferably comprised from one bulkhead 141 to the other bulkhead 141.

The scraper 160 comprises a free edge 167 configured to contact the dragging surface 151. The free edge 167 coincides with an end edge of the scraping blade 166. The free edge 167 is configured to contact in a scraping manner the dragging surface 151 along the entire transverse extension thereof.

The scraper 160 further comprises a deflection surface 168 adjacent to the free edge 167 and developed away from the free edge 167. The deflection surface 168 is defined on a surface of the scraping blade 166.

The deflection surface 168 is arranged tangentially to the dragging surface 151 at the free edge 167. Preferably, the deflection surface 168 has an inclination comprised between 1° and 90°, preferably between 15° and 75°, even more preferably between 30° and 60°, for example about 45° with respect to the conveying surface 16.

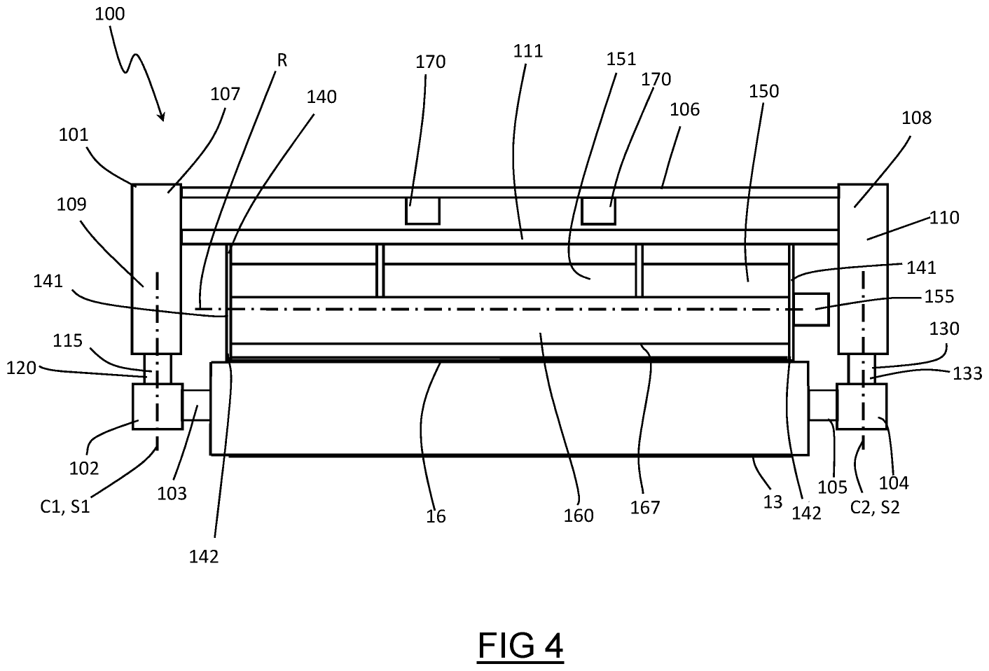

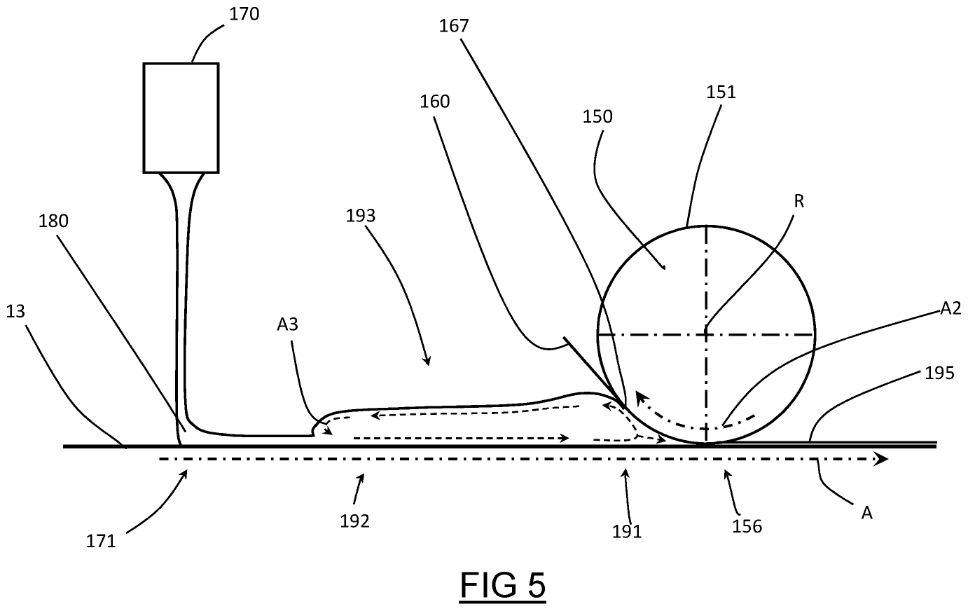

One or more adhesive resin dispensers 170, schematically illustrated in FIGS. 4 and 5, are fixed to the support frame 101 on a delivery zone 171 on the conveying surface 16 upstream of the dragging body 150 with respect to the advancement direction A. The resin dispensers 170 are configured to deliver adhesive resin 180 in the liquid state on the conveying surface 16 at the delivery zone 171.

The adhesive resin 180 may be a polyurethane resin brought to the liquid state by addition of special solvents. The solvents evaporate after a certain time from the delivery of the adhesive resin 180 or upon reaching a predetermined temperature, allowing the adhesive resin 180 to harden.

The delivery of the adhesive resin 180 from the dispensers 170 onto the conveying surface 16 may take place for example by gravity, so that the adhesive resin 180 is made to drip onto the conveying surface 16.

In use, the process described below is followed in order to prepare a conveying surface to receive a substrate in a printing process.

The conveying surface 16 to be prepared may have adhesive layers already applied previously, which are worn, damaged or have degraded. The layers already present can be removed, for example by washing the conveying surface 16. Alternatively, the operations described below can be carried out on the adhesive layers already present on the conveying surface 16.

The resin application device 100 is mounted on the conveyor belt 13.

The dragging body 150 is placed in contact with the conveying surface 16, preferably at the contact zone 156. The relative position between the dragging body 150 and the conveying surface 16 is regulated such that the dragging body 150 contacts the conveying surface 16.

For this purpose, the dragging body 150 is moved along the first sliding direction S1 and the second sliding direction S2 to place it into contact with the conveying surface 16. The regulation of the position of the dragging body 150 takes into account the thickness from the conveying surface 16, which comprises a possible layer of adhesive resin 180 already present on the conveying surface 16.

The position of the dragging body 150 is regulated along the first sliding direction S1 and the second sliding direction S2 by sliding the guide mechanisms 115, 130 so as to adapt the distance between the second portion 106 of the support frame 101 and the first portions 102, 104.

Subsequently or simultaneously, the pressure that the dragging body 150 exerts on the conveying surface 16 is regulated.

The pressure that the dragging body 150 exerts on the conveying surface 16 is regulated by exerting at least one compensation force on the second portion 106 of the support frame 101 directed away from the first portion 102 of the support frame 101.

Such at least one compensation force is set so as to compensate, by cancelling out, for the weight that the dragging body 150, the second portion 106 of the support frame 101 and any other components supported by the second portion 106 of the support frame 101, exert on the support surface 16.

Once the compensation force has been set, at least one compressive force is exerted on the second portion 106 of the support frame 101 directed towards the first portion 102 of the support frame 101.

This compressive force is set so as to obtain a desired pressure of the dragging body 150 on the conveying surface 16.

This pressure is chosen according to the type of adhesive resin used, the characteristics of the conveying surface 16 and the characteristics of the dragging body 150.

This pressure is chosen to ensure a compression action on the adhesive resin such as to allow an even and desired thickness distribution on the conveying surface during the resin application process.

A person expert in the field will be able to carry out tests to choose the most suitable pressure that allows the above to be achieved.

The compensation force is exerted on the second portion 106 of the support frame 101 by the compensators of the load regulators 120, 133 and is regulated by acting on the respective load adjusters.

Similarly, the compressive force is exerted on the second portion 106 of the support frame 101 by the load regulator pressors 120, 133 and is regulated by acting on the respective load adjusters.

Subsequently, adhesive resin 180 is delivered onto the conveying surface 16 at the delivery zone 171. The adhesive resin 180 is delivered by the dispensers 170, which release a predetermined amount that is preferably constant over time. The delivered adhesive resin 180 drips onto the conveying surface 16 by gravity.

While the adhesive resin 180 is being delivered, the conveying surface 16 is advanced in the advancement direction A by rotating the conveyor belt 13 in the first angular direction A1. The conveying surface 16 is advanced with a speed comprised between 0.06 metres/second and 0.1 metres/second.

The delivered adhesive resin 180 contacts the conveying surface 16 and is conveyed from the conveying surface 16 to downstream of the delivery zone 171.

Simultaneously or previously, the dragging body 150 is set into rotation about the rotation axis R in the second angular direction A2. This is actuated by driving the motor 155.

In the contact zone 156 between the dragging body 150 and the conveying surface 16, the dragging surface 151 of the dragging body 150 has a tangential speed directed opposite with respect to the advancement speed of the conveying surface 16.

The dragging surface tangential speed 151 is maintained between 0.02 metres/second and 0.05 metres/second.

In this configuration, the dragging body 150 slides on, i.e. is in contact with and has a relative movement with respect to, the conveying surface 151 at the contact zone 156.

The adhesive resin 180 conveyed by the conveying surface 16 reaches a first region 191, downstream of the delivery zone 171. The first region 191 is defined at the position of the dragging body 150. The first region 191 is placed upstream of and adjacent to the contact zone 156. Before reaching the first region 191, the adhesive resin 180 conveyed by the conveying surface 16 crosses a second region 192 placed upstream of the first region 191 and downstream of the delivery zone 171. This second region is adjacent to the first region 191.

In the first region 191, the dragging body 150 comes into contact with the adhesive resin 180 that is intercepted by the dragging surface 151. The adhesive resin 180 intercepted by the dragging surface 151 adheres to the dragging surface 151 and is dragged tangentially to the dragging surface 151.

In particular, the moving dragging surface 151 transmits a dragging force to the adhesive resin 180 at the first region 191. Such a dragging force is, in the contact zone 156 between the dragging body 150 and the conveying surface 16 directed parallel to the conveying surface 16 and opposite to the advancement direction A. The dragging force changes direction along the dragging surface 151 of the dragging body 150 being the dragging force tangential to the dragging surface 151 and the dragging surface 151 being cylindrical. In any case, the dragging force, at the first region 191, has a component directed on the opposite side with respect to the advancement direction A.

The adhesive resin adheres to the dragging surface 151 by effect of the viscosity of the adhesive resin and by effect of the adhesiveness of the adhesive resin itself. The adhesive resin, in fact, even when not yet activated has adhesiveness, albeit very limited.

The adhesive resin 180 is then dragged by the dragging surface 151 and is raised by the conveying surface 16.

Note that not all of the adhesive resin deposited on the conveying surface 16 is raised from the conveying surface 16, as a minor fraction of the adhesive resin deposited on the conveying surface 16 adheres thereto and passes beyond the first region 191 and reaches the contact zone 156.

The raised adhesive resin 180 is intercepted by the scraper 160, which removes it, in whole or in part, from the dragging surface 151.

The adhesive resin 180 is removed from the dragging surface 151 by the free edge 167 of the scraper 160, in scraping contact with the dragging body 150. The scraper 160 prevents at least part of the raised adhesive resin 180 from passing between the free edge 167 and the dragging body 150.

The raised adhesive resin 180 is then diverted towards the second region 192.

For this purpose, the adhesive resin removed from the dragging surface 151 by the free edge 167 of the scraper 160 is withdrawn from the deflection surface 168 which directs it towards the second region 192. The adhesive resin 180 directed towards the second region 192 moves away from the deflection surface 168 and, retaining its own amount of motion, follows a path parallel to the conveying surface 16 in the opposite direction to the advancement direction A.

The adhesive resin 180 then moves from the first region 191 to the second region 192 above and in the opposite direction to the advancement direction of the adhesive resin 180 conveyed on the conveying surface and coming from the delivery zone 171.

By effect of the viscosity of the adhesive resin, the two layers of adhesive resin (i.e., the adhesive resin proceeding from the first region 191 to the second region 192 and the adhesive resin proceeding from the second region 192 to the first region 191) tend to mix together creating a recirculation zone 193 between the second region 192 and the first region 191.

In this recirculation zone 193 the adhesive resin undergoes a continuous mixing process without forming stagnation zones or regions at the contact zone 156 where the adhesive resin can accumulate.

In the recirculation zone 193 the dragged adhesive resin 180 recirculates in a third angular direction A3 opposite to the first angular direction A1 and to the second angular direction A2.

To keep the adhesive resin 180 in the recirculation zone 193 on the conveying surface 16 and to prevent the adhesive resin from falling laterally from the conveying surface 16, it is provided to delimit the recirculation zone 193 laterally.

The recirculation zone 193 is delimited by the side bulkheads 141 which are kept in scraping contact with the conveying surface 16.

The adhesive resin not removed from the dragging surface 151 and which has adhered to the conveying surface 16 reaches the contact zone 156 between the dragging body 150 and the conveying surface 16. This adhesive resin passes, conveyed by the conveying surface 16 below the dragging body 150.

The dragging body 150, by effect of the pressure exerted on the conveying surface 16, evenly spreads the adhesive resin 180 passing between the conveying surface 16 and the dragging body 150 and forms an even layer 195 of adhesive resin 180 on the conveying surface 16 downstream of the first region 191.

The conveyor belt 13 is rotated so as to make successive complete rotations while adhesive resin 180 is being delivered onto the conveying surface 16, forming even, successive and overlapping layers 195 of adhesive resin 180.

The even layer 195 formed during each rotation of the conveyor belt 13 has a thickness that is thin enough to allow a partial evaporation of the solvents that cause a partial hardening, or drying, of the even layer 195 of resin before the subsequent rotation of the conveyor belt 13.

The even layers 195 are superimposed on top of each other until reaching a pre-established thickness of adhesive resin spread on the conveying surface 16, preferably of about 0.15 millimetres.

After the application of resin, a sufficient time is awaited for the complete evaporation of the solvents contained in the adhesive resin 180, for example a time comprised between four and eight hours.

The thus resin-coated conveyor belt 13 can be associated with an inkjet printer (not illustrated). Before associating the conveyor belt 13 with the printer, the resin application device 100 is removed from the conveyor belt 13.

For activating the adhesive resin 180 on the conveying surface, the adhesive resin 180 can be heated before starting a printing process. Alternatively, an adhesive resin 180 that activates upon evaporation of the solvents may be used.

To print a substrate, a first conveying surface may be coated with resin as described above and be associated with an inkjet printer. In a manner known in the state of the art, a substrate is made to adhere on the first conveying surface, the substrate is advanced through a printing zone in the inkjet printer, and printing ink is transferred to the substrate in the printing zone.

While the first conveying surface is being used for printing, a second conveying surface may be coated with resin.

When the adhesive resin on the first conveying surface has deteriorated, for example it is worn out or foreign material has attached thereto compromising its adhesiveness or evenness, printing is interrupted and the first conveying surface is removed from the inkjet printer. Subsequently, the first conveying surface is moved away from the printing zone and the second conveying surface is brought to the inkjet printer at the printing zone.

Subsequently, printing is resumed by making a substrate adhere to the second conveying surface, advancing the substrate through a printing zone in the inkjet printer by means of the second conveying surface, and transferring printing ink to the substrate in the printing zone.

While the second conveying surface is being used for printing, the first conveying surface can be coated with resin again as described above.

1. A resin application device for a conveying surface in a printing process, comprising:
an adhesive resin dispenser configured to deliver adhesive resin onto a conveying surface;
a dragging body rotatably mounted about a rotation axis and configured to come into contact with the conveying surface, wherein in a contact zone between the dragging body and the conveying surface, the dragging body and the conveying surface have respective advancement directions directed opposite to each other;
a motor connected to said dragging body for setting into rotation said dragging body about said rotation axis;
a support frame on which said dragging body is mounted and configured to be mounted on the conveying surface.

2. The resin application device of claim 1, comprising a scraper placed in contact with said dragging body and configured to remove at least a part of adhesive resin from said dragging body.

3. (canceled)

4. The resin application device of claim 1, wherein said dragging body is a cylindrical body.

5. (canceled)

6. The Resin application device of claim 1, wherein said support frame comprises at least one first portion stably constrainable to a frame of a conveyor belt provided with said conveying surface, and a second portion slidingly coupled to said at least one first portion along a first sliding direction; said dragging body being rotatably mounted on said second portion.

7. The resin application device of claim 6, wherein said support frame comprises at least one load regulator interposed between the at least one first portion of the support frame and the second portion of the support frame; said at least one load regulator being configured to selectively regulate a pressure that the dragging body exerts against the conveying surface.

8. The resin application device of claim 7, wherein said at least one load regulator comprises at least a first compensator configured to exert a selectively adjustable force on the second portion of said support frame directed away from the at least one first portion of said support frame.

9. The resin application device of claim 7, wherein said at least one load regulator comprises at least one first pressor configured to exert a selectively adjustable force on the second portion of said support frame directed towards the at least one first portion of said support frame.

10. The resin application device of claim 7, wherein said at least one load regulator comprises:
at least one first compensator configured to exert a force on the second portion of said support frame directed away from the at least one first portion of said support frame to cancel a weight force that said dragging body and said second portion of the support frame exert on the conveying surface; and
at least one first pressor configured to exert a selectively adjustable force on the second portion of said support frame directed towards the at least one first portion of said support frame to increase the pressure that said dragging body exerts on the conveying surface.

11. An assembly for preparing a conveying surface to receive a substrate in a printing process, comprising:
a conveying surface movable along an advancement direction;
the resin application device of claim 1 and operating on said conveying surface;
wherein said dragging body is in contact with said conveying surface.

12. The assembly of claim 11, wherein said conveying surface is defined by a surface of a conveyor belt wound on pulleys configured to rotate the conveyor belt in a first angular direction; said dragging body rotating around said rotation axis in a second angular direction concordant with said first angular direction.

13-15. (canceled)

16. A method of preparing a conveying surface to receive a substrate in a printing process, comprising:
moving the conveying surface along an advancement direction;
delivering adhesive resin at a delivery zone on the conveying surface;
displacing at least part of the adhesive resin from a first region on the conveying surface downstream of the delivery zone to a second region on the conveying surface upstream of the first region;
forming an even layer of adhesive resin on the conveying surface downstream of the first region;
wherein displacing at least part of the adhesive resin from the first region to the second region comprises dragging adhesive resin to be displaced towards the second region to form a recirculation zone of adhesive resin between the first region and the second region.

17. The method claim 16, wherein;
dragging the adhesive resin to be displaced towards the second region comprises exerting on the adhesive resin to be displaced a dragging force having a component directed opposite with respect to the advancement direction, and
exerting on the adhesive resin to be displaced a dragging force comprises arranging a dragging body in said first region in contact with the conveying surface, contacting the adhesive resin with said dragging body and moving said dragging body.

18-19. (canceled)

20. The method of claim 17, wherein moving said dragging body comprises moving said dragging body with a displacement component directed opposite to the advancement direction.

21. The method of claim 17, wherein moving said dragging body comprises setting into rotation said dragging body about a rotation axis transverse to the advancement direction and contained in a plane parallel to the advancement direction.

22. The method of claim 21, wherein moving the conveying surface along the advancement direction comprises rotating a conveyor belt, provided with said conveying surface, in a first angular direction, and wherein setting into rotation said dragging body comprises setting into rotation said dragging body in a second angular direction concordant with the first angular direction.

23. The method of claim 16, wherein displacing at least part of the adhesive resin from the first region to the second region comprises raising adhesive resin from the conveying surface at the first region, and
wherein displacing at least part of the adhesive resin from the first region to the second region of adhesive resin comprises, subsequent to raising the adhesive resin from the conveying surface, directing raised adhesive resin towards the second region.

24. (canceled)

25. The method of claim 23, wherein:
exerting on the adhesive resin to be displaced a dragging force comprises arranging a dragging body in said first region, contacting the adhesive resin with said dragging body and moving said dragging body;
directing raised adhesive resin towards the second region comprises removing adhesive resin from the dragging body and diverting it towards the second region; and
removing adhesive resin from the dragging body and diverting it towards the second region comprises placing a scraper in contact with the dragging surface of the dragging body.

26-28. (canceled)

29. The method of claim 25, wherein forming an even layer of adhesive resin on the conveying surface comprises passing adhesive resin between the dragging body and the conveying surface and spreading with said dragging body the adhesive resin on the conveying surface.

30. (canceled)

31. A method of printing a substrate, comprising:
preparing a first conveying surface to receive a substrate in a printing process according to the method of claim 16;
making a substrate adhere to the first conveying surface and transferring printing ink to the substrate in a printing zone.

32. The method of claim 31, further comprising:
preparing a second conveying surface to receive a substrate in a printing process according to the method of claim 16;
moving said first conveying surface away from the printing zone when the adhesive resin on said first conveying surface has deteriorated;
bringing said second conveying surface at the printing zone;
making a substrate adhere to the second conveying surface and transferring printing ink to the substrate in the printing zone.
